(19) United States
(12) Patent Application Publication
(10) Pub. No.: US 2020/0313473 A1
(43) Pub. Date: Oct. 1, 2020

(54) ELECTRIC MOTOR HAVING SPLIT CORE STATOR

(71) Applicant: Fanuc Corporation, Minamitsuru-gun (JP)

(72) Inventor: Yasuo Yamada, Minamitsuru-gun (JP)

(73) Assignee: Fanuc Corporation, Minamitsuru-gun (JP)

(21) Appl. No.: 16/830,979

(22) Filed: Mar. 26, 2020

(30) Foreign Application Priority Data
Mar. 29, 2019 (JP) 2019-069191

(51) Int. Cl. H02K 1/14; H02K 1/02; H02K 1/26; H02K 1/18; H02K 1/16; H02K 3/28

(52) U.S. Cl. CPC H02K 1/148; H02K 1/02; H02K 3/28; H02K 1/18; H02K 1/16; H02K 1/26

(57) ABSTRACT

An electric motor includes a rotor; a first stator provided with a plurality of teeth, and a second stator stacked in an axial direction of the first stator, the teeth of the second rotor being disposed and aligned with the corresponding plurality of teeth of the first stator in the axial direction. The first and the second stator are formed of a plurality of split cores being split along a plurality of split surfaces. A position of each of the split surfaces of the second stator is displaced from a position of the corresponding one of the split surfaces of the first stator in the circumferential direction by an angle α (α=(2π/N)/2+n×(2π/N), where N is a least common multiple of the number of magnetic poles of the rotor and the number of split cores, and n is an integer).

### BACKGROUND OF THE INVENTION

### 1. Field of the Invention

The present invention relates to an electric motor having a split core stator.

### 2. Description of the Related Art

In an electric motor having a stator provided with a core composed of a plurality of split cores that are split in a circumferential direction, magnetic resistance of a split surface, the split surface being an interface between the split cores, is higher than magnetic resistance of the core itself. As a result, the split surface may cause torque pulsation during rotation, which is inherently undesirable.

Thus, an electric motor for the purpose of reducing torque pulsation and cogging torque has been proposed (e.g., refer to JP 2014-117043 A and JP 2016-163421 A). JP 2014-117043 A discloses a motor including: a stator core formed by layering entire circumferential cores, the entire circumferential core being formed by connecting a plurality of split cores in an arc-like shape into an annular shape; and a rotor holding a magnet, each of the split cores being formed by curving a linear split core having a plurality of teeth connected linearly, the circumferential cores each being layered with connection portions of the split cores, the connection portions being disposed at a plurality of circumferential positions that are different from each other, the number of circumferential positions of the respective connection portions being set to a predetermined value, thereby dispersing and canceling variation components in cogging torque, the variation components being caused by variations in a radius of the entire circumference cores, thereby reducing variations of the cogging torque.

In addition, JP 2016-163421 A discloses a permanent magnetic rotary electric machine with P poles and S slots, the permanent magnetic rotary electric machine including a stator iron core that has an entire circumference defined by layered iron cores each formed by layering an electromagnetic steel plate in a direction of an axis of rotation by an arbitrary unit length, the electromagnetic steel plate having a section punched out in a rotational circumferential direction by a length three times or more and S/2 times or less larger than a slot pitch, the layered iron cores being connected and stacked in the direction of the axis of rotation by D steps, the layered cores stacked in the second step and subsequent steps being displaced with respect to the layered iron core in the first step, by an angle E which is a multiple of a slot pitch, per each step in the rotational circumferential direction, D and E being each set to a value for dispersing an effect in three phases, the effect being from reduction in the amount of magnetic flux of teeth caused by a split of the stator iron core in the rotational circumferential direction.

Unfortunately, electric motors in the related art have a problem in that they have various constraints in the way of displacing a split surface, which is affected by a combination of the number of poles and the number of slots.

### SUMMARY OF THE INVENTION

It is an object of the present invention to provide an electric motor capable of suppressing torque pulsation caused by influence of a split surface, the split surface being an interface between split cores.

An electric motor according to an example of the present disclosure includes: a rotor having a plurality of magnetic poles; a first stator provided with a plurality of teeth for winding a coil on its inner circumferential side, the first stator being disposed in an annular shape facing radially the rotor, the first stator being formed of a plurality of split cores each having the teeth identical in number, the split cores being split along a plurality of split surfaces in a circumferential direction; and a second stator stacked in an axial direction of the first stator, the second stator provided with a plurality of teeth identical in number with the plurality of teeth of the first stator, the teeth being disposed and aligned with the corresponding plurality of teeth of the first stator in the axial direction, the second stator being formed of a plurality of split cores being split along a plurality of split surfaces in the circumferential direction, wherein a position of each of the split surfaces of the second stator is displaced from a position of the corresponding one of the split surfaces of the first stator in the circumferential direction by an angle α, and the angle α is determined by an equation, α=(2π/N)/2+n×(2π/N), where N is a least common multiple of the number of magnetic poles of the rotor and the number of split cores, and n is an integer.

The electric motor according to the example of the present disclosure enables suppressing torque pulsation caused by influence of the split surfaces being interfaces between the split cores.

### BRIEF DESCRIPTION OF THE DRAWINGS

FIG. 1 is a perspective view of a first stator and a second stator constituting an electric motor according to Example 1 of the present disclosure.

FIG. 2 is a plan view of the first stator constituting the electric motor according to Example 1 of the present disclosure.

FIG. 3A is a diagram illustrating torque pulsation caused, when a rotor rotates, by split surfaces of the first stator constituting the electric motor according to Example 1 of the present disclosure. FIG. 3B is a diagram illustrating a positional relationship between split surfaces of the first stator and magnetic poles of the rotor, constituting the electric motor according to Example 1 of the present disclosure.

FIG. 4A is a diagram illustrating torque pulsation caused, when a rotor rotates, by split surfaces of the first stator constituting the electric motor according to Example 1 of the present disclosure. FIG. 4B is a diagram illustrating torque pulsation caused, when the rotor rotates, by split surfaces of the second stator constituting the electric motor according to Example 1 of the present disclosure.

FIG. 5 is a diagram illustrating a result of synthesis of the torque pulsation of FIG. 4A and the torque pulsation of FIG. 4B.

FIG. 6 is a diagram illustrating a positional relationship between split surfaces of the first stator and the second stator and magnetic poles of the rotor, constituting the electric motor according to Example 1 of the present disclosure.

FIG. 7 is a plan view illustrating the positions of split surfaces of a split core of the first stator constituting the electric motor according to Example 1 of the present disclosure.

FIG. 8A is a plan view of a split core of the first stator constituting the electric motor according to Example 1 of the present disclosure. FIG. 8B is a plan view of a split core of the second stator constituting the electric motor according to Example 1 of the present disclosure.

FIG. 9 is a plan view of a state in which a split core of the first stator and that of the second stator, constituting the electric motor according to Example 1 of the present disclosure, are stacked with each other.

FIG. 10 is a perspective view of a state in which a split core of the first stator and that of the second stator, constituting the electric motor according to Example 1 of the present disclosure, are stacked with each other.

FIG. 11 is a plan view of a first stator constituting an electric motor according to Example 2 of the present disclosure.

### DETAILED DESCRIPTION

Hereinafter, an electric motor according to the present disclosure is described with reference to the drawings. However, the technical scope of the invention is not limited to these embodiments and includes the invention described in the scope of claims and elements equivalent thereto.

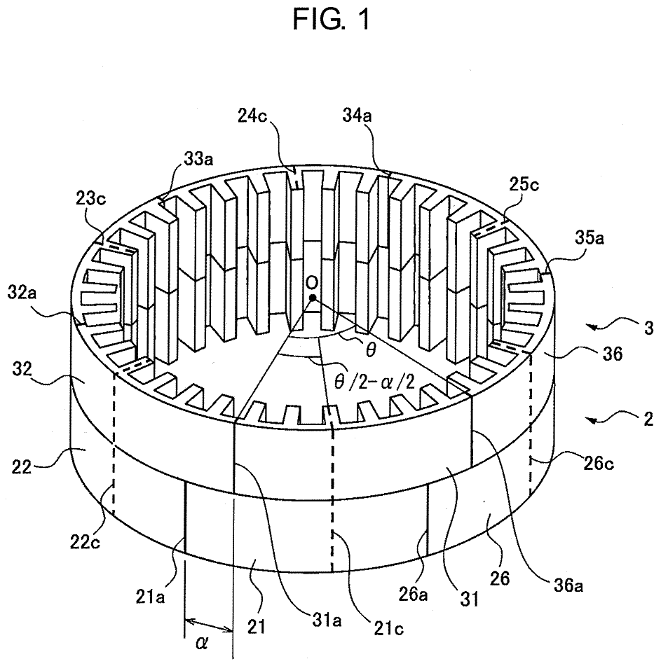

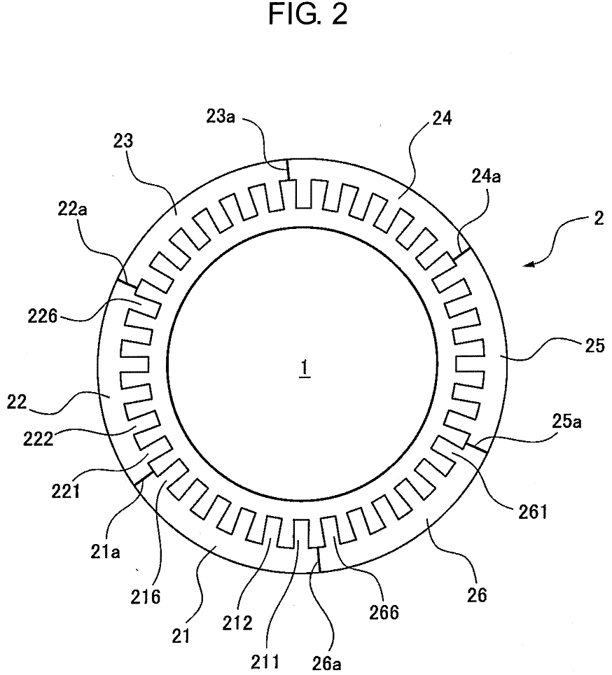

FIG. 1 illustrates a perspective view of a first stator and a second stator constituting an electric motor according to Example 1 of the present disclosure. FIG. 2 illustrates a plan view of the first stator constituting the electric motor according to Example 1 of the present disclosure. The electric motor according to Example 1 of the present disclosure includes a rotor 1, a first stator 2, and a second stator 3.

The rotor 1 has a plurality of magnetic poles. For example, the rotor 1 has 42 magnetic poles. However, the present disclosure is not limited to these examples.

The first stator 2 includes a plurality of teeth (211, 212, . . . , 216, 221, 222, . . . , 226, . . . , 261, . . . , 266) on its inner circumferential side for winding a coil (not illustrated). In the example illustrated in FIG. 1 and FIG. 2, the first stator 2 has 36 of the teeth (211, 212, . . . , 216, 221, 222, . . . , 226, . . . , 261, . . . , 266). However, the present disclosure is not limited to these examples.

The first stator 2 includes a plurality of split cores (21, 22, . . . , 26) disposed in an annular shape facing radially the rotor 1, each having teeth identical in number (e.g., six), the split cores being split along a plurality of split surfaces (21a, 22a, . . . , 26a) in a circumferential direction. In the example illustrated in FIG. 1 and FIG. 2, the first stator 2 includes six of the split cores (21, 22, . . . , 26) split along six of the split surfaces (21a, 22a, . . . , 26a). However, the present disclosure is not limited to these examples. In addition, each split core preferably has the same shape.

The split cores are preferably manufactured by stacking a plurality of electromagnetic steel plates. Here, when the plurality of split cores has the same shape, each split core can be manufactured by stacking electromagnetic steel plates having a single shape.

The second stator 3 is layered on the first stator 2 in its axial direction. The second stator 3 includes a plurality of teeth identical in number with the plurality of teeth of the first stator 2, being disposed and aligned with the corresponding plurality of teeth of the first stator 2. In other words, as illustrated in FIG. 1 and FIG. 2, when the first stator 2 includes 36 of the teeth (211, 212, . . . , 266), the second stator 3 also has 36 teeth. In addition, the teeth of the first stator 2 and the teeth of the second stator 3 are disposed stacked with each other in the axial direction, and each of the teeth of the first stator 2 and the corresponding one of the teeth of the second stator 3 constitute one tooth as a whole.

The first stator 2 preferably has a length in the axial direction equal to a length of the second stator 3 in the axial direction.

When the electromagnetic steel plate constituting the first stator 2 has a thickness equal to a thickness of the electromagnetic steel plate constituting the second stator 3, the first stator 2 preferably has stacked electromagnetic steel plates identical in number or substantially identical in number with stacked electromagnetic steel plates of the second stator 3.

While FIG. 1 illustrates an example in which the second stator 3 is stacked on the first stator 2 forming a two-step structure, the second stator 3 is not limited to this example, and the first stator 2 may be stacked on the second stator 3, or an even-step structure with four or more steps may be formed.

When a minimum unit of each of the first stator 2 and the second stator 3 is considered as one electromagnetic steel plate, even the first stator 2 and the second stator 3 being each formed by layering the same or substantially same number of electromagnetic steel plates can be applied to the electric motor according to the present example. In addition, the first stator 2 and the second stator 3 may be layered one by one.

The second stator 3 includes a plurality of split cores (31, 32, . . . , 36) split along a plurality of split surfaces (31a, 32a, . . . , 36a) in the circumferential direction.

The split surfaces (31a, 32a, . . . , 36a) of the second stator are positioned displaced from the corresponding split surfaces (21a, 22a, . . . , 26a) of the first stator by an angle α in the circumferential direction, and the angle α is determined by the following equation;

α=(2π/N)/2+n×(2π/N),

where N is a least common multiple of the number of magnetic poles of the rotor and the number of split cores, and n is an integer.

In this case, when the number of magnetic poles of the rotor is set to 42 and the number of split cores is set to 6, a least common multiple of the numbers is 42. Thus, the value of α is determined as π/42, 3π/42, 5π/42, . . . (rad).

As described below, the split core 21 and the Split core 31 each have a shape inverted across an inversion symmetry axis 21c. Other split cores of the first stator 2 and the second stator 3 also have shapes inverted across respective inversion symmetry axes 22c to 26c.

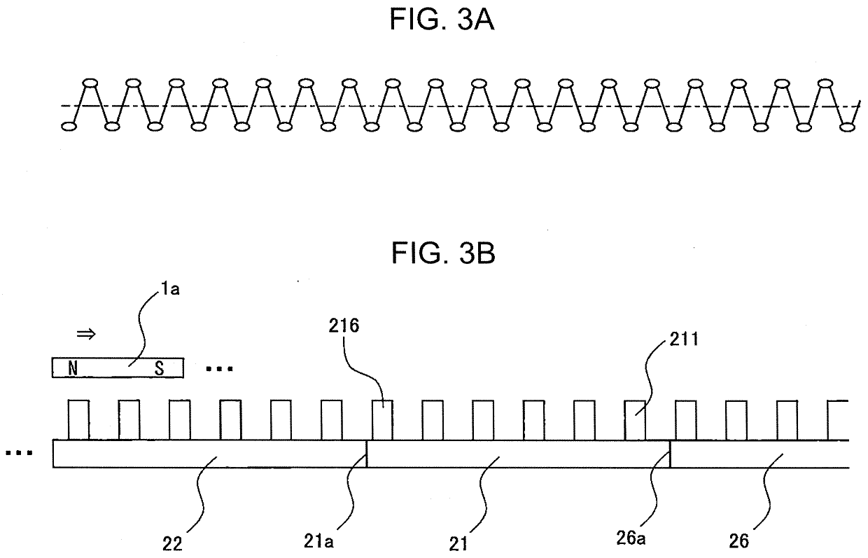

Next, a relationship between positions of the split surfaces and torque pulsation will be described. First, torque pulsation caused by the first stator 2 provided alone will be described. FIG. 3A is a diagram illustrating torque pulsation caused, when a rotor rotates, by split surfaces of the first stator constituting the electric motor according to Example 1 of the present disclosure. FIG. 3B is a diagram illustrating a positional relationship between split surfaces of the first stator and magnetic poles of the rotor, constituting the electric motor according to Example 1 of the present disclosure. FIG. 3B illustrates a stator by substituting a linear shape for an annular shape. As illustrated in FIG. 3B, when one magnetic pole pair 1a of the rotor 1 disposed facing the plurality of teeth of the first stator 2 moves, torque pulsation is caused when the magnetic pole pair 1a passes through the split surface 21a. When the rotor 1 having 42 magnetic poles makes one revolution, torque pulsation is caused by a least common multiple of the number of magnetic poles of the rotor 1 and the number of split cores (21 to 26) as illustrated in FIG. 3A. In the present example, the number of split surfaces is six, with the result that 42 torque pulsation are caused per revolution.

When the first stator 2 has the split surfaces at the same positions in the axial direction as those of the corresponding split surfaces of the second stator 3, torque pulsation are caused in the split surfaces of the second stator 3 at the same positions as those of the corresponding split surfaces of the first stator 2. In other words, this case causes torque pulsation to be twice as large as the torque pulsation illustrated in FIG. 3A.

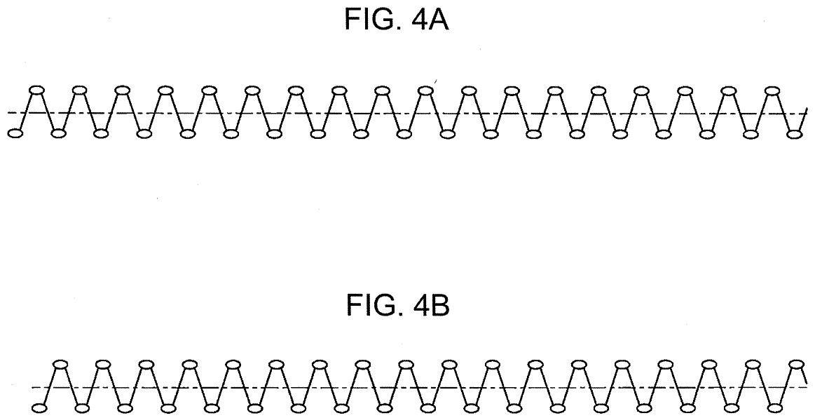

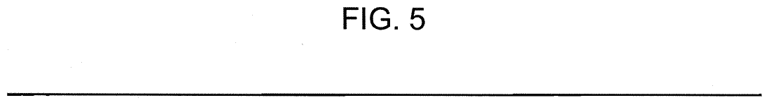

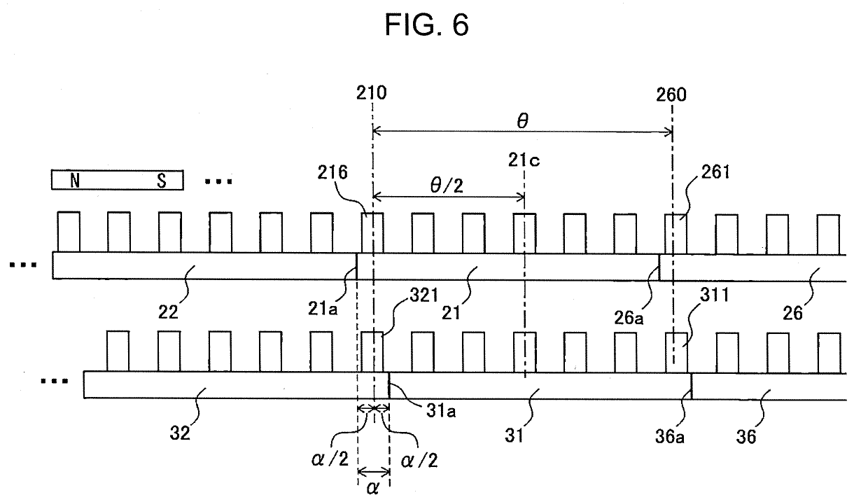

In contrast, the electric motor according to the present example is configured such that the split surfaces of the second stator 3 are disposed at positions displaced from positions of the corresponding split surfaces of the first stator 2 to suppress torque pulsation. FIG. 4A is a diagram illustrating torque pulsation caused, when a rotor rotates, by split surfaces of the first stator constituting the electric motor according to Example 1 of the present disclosure. FIG. 4B is a diagram illustrating torque pulsation caused, when a rotor rotates, by split surfaces of the second stator constituting the electric motor according to Example 1 of the present disclosure. FIG. 5 is a diagram illustrating a result of synthesis of the torque pulsation of FIG. 4A and the torque pulsation of FIG. 4B. FIG. 6 is a diagram illustrating a positional relationship between split surfaces of the first stator and the second stator and magnetic poles of the rotor, constituting the electric motor according to Example 1 of the present disclosure.

As illustrated in FIG. 4A, torque is pulsated N times per one revolution of the rotor 1 due to the split surfaces of the first stator 2. Thus, the torque pulsation has a period of 2π/N. The second stator 3 is also formed with split surfaces, so that similarly, torque is pulsated N times per one revolution of the rotor 1 as illustrated in FIG. 4B, and the torque pulsation has a period of 2π/N.

The torque pulsation is caused when the magnetic poles of the rotor 1 pass through the split surfaces. Thus, when the split surfaces of the second stator 3 are provided at respective positions different from positions of the corresponding split surfaces of the first stator, the period of the torque pulsation caused in the first stator 2 can be deviated from the period of the torque pulsation caused in the second stator 3. Total torque pulsation acquired by synthesizing the torque pulsation caused in the first stator 2 and the torque pulsation caused in the second stator 3 becomes minimum when the torque pulsation caused in the first stator 2 and the torque pulsation caused in the second stator 3 deviate by a half-period. The torque pulsation has a period of 2π/N, such that the half-period is (2π/N)/2. Thus, the split surfaces of the second stator 3 are provided at respective positions displaced from positions of the corresponding split surfaces of the first stator by the half-period, i.e., (2π/N)/2.

While the above description relates to the case where the position of each of the split surfaces of the second stator 3 is displaced by the half-period from the position of the corresponding one of the split surfaces of the first stator, the torque pulsation can be suppressed due to further displacement by n periods (n is an integer). Accordingly, when the position of the split surface (e.g., 31a) of the second stator 3 is displaced from the position of the split surface (e.g., 21a) of the first stator 2 by the angle α in the circumferential direction, torque pulsation can be suppressed by setting the angle α as in the following equation (1).

α=(2π/N)/2+n×(2π/N) (1)

where N is a least common multiple of the number of magnetic poles of the rotor and the number of split cores, and n is an integer.

As described above, when the positions of the split surfaces of the second stator 3 are each displaced by the angle α with respect to the position of the corresponding one of the split surfaces of the first stator, the torque pulsation is approximately flat on the whole as illustrated in FIG. 5. Accordingly, when the split surfaces of the first stator 2 are positioned displaced from the corresponding split surfaces of the second stator 3 by the angle α, the torque pulsation can be suppressed.

In addition, as illustrated in FIG. 6, each of the teeth of the first stator 2 is disposed at the same position in the axial direction as that of the corresponding one of the teeth of the second stator 3. For example, when a center line of the tooth 216 and a tooth 321 is designated as 210 and when a center line of the tooth 261 and a tooth 311 is designated as 260, an angle formed by the center lines 210 and 260 corresponds to an interior angle θ of one split core. In addition, when a center line between the split surface 21a and the split surface 31a is set to be aligned with the center line 210, an angle from the center line 210 to the split surface 21a is α/2, and an angle from the center line 210 to the split surface 31a is −α/2.

When a center line between the center lines 210 and 260 designated as 21c, an angle from the center line 21c to the split surface 21a is θ/2+α/2, and an angle from the center line 21c to the split surface 31a is θ/2−α/2. Similarly, an angle from the center line 21c to the split surface 26a is θ/2−α/2, and an angle from the center line 21c to the split surface 36a is θ/2+α/2. From the above, it can be seen that the split core 21 and the split core 31 are disposed at respective positions inverted across the center line 21c serving as an inversion symmetry axis.

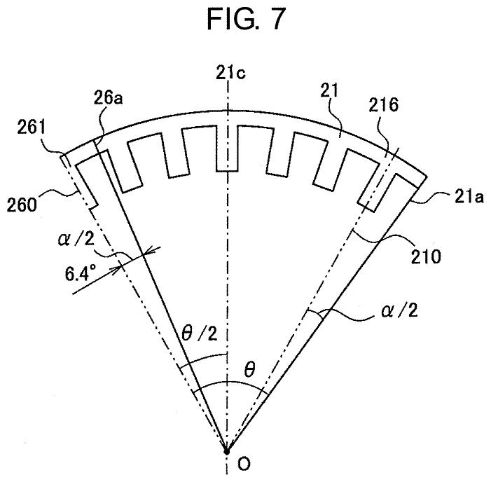

FIG. 7 illustrates a plan view of the split core 21 of FIG. 6. A line connecting a center O of the first stator 2 and the center of the tooth 216 is the center line 210, and a line connecting the center O of the first stator 2 and the center of the tooth 261 is the center line 260. When the center of the center line 210 and the center line 260 serves as the inversion symmetry axis 21c, an angle formed by the center line 210 and the center line 260 is an interior angle of one split core, an angle formed by the inversion symmetry axis 21c and the center line 210 is θ/2, and an angle formed by the inversion symmetry axis 21c and the center line 260 is θ/2. As illustrated in FIG. 6, an angle formed by the center line 210 and the split surface 21a is α/2, an angle formed by the inversion symmetry axis 21c and the split surface 21a is θ/2+α/2. Similarly, an angle formed by the center line 260 and the split surface 26a is α/2, and an angle formed by the inversion symmetry axis 21c and the split surface 26a is θ/2−α/2.

As described above, one split core being freely selected (e.g., 31) of the plurality of split cores of the second stator 3 has a shape acquired by inverting a split core (e.g., 21) of the plurality of split cores of the first stator 2 across an inversion symmetry axis (e.g. 21c), the split core disposed to at least partly overlap with the one split core. In addition, when the inversion symmetry axis 21c passes through a predetermined tooth (e.g., 213) included in the split core 21 of the first stator 2 and the center O of the first stator 2 or passes through a predetermined slot and the center of the first stator 2, and an interior angle of the split core 21 of the first stator 2 is designated as θ, an angle formed by the inversion symmetry axis 21c and the split surface 26a of the split core 21 of the first stator 2 is represented by θ/2−α/2, and an angle formed by the inversion symmetry axis 21c and the split surface 36a of the one split core 31 of the second stator 3 is represented by θ/2+α/2.

As described above, the angle α that determines a position of a split surface can take a plurality of values. Thus, the split surface can be set to various positions on the circumference according to the set value of α. However, at least one split surface of the plurality of split surfaces of the first stator 2 and at least one split surface of the plurality of split surfaces of the second stator 3 are each preferably disposed in a region between adjacent teeth of the plurality of teeth. This is because, when the split surface is disposed in a portion formed with a tooth, the cross-sectional area of the split surface increases compared to when the split surface is formed in a portion formed with no tooth, and torque pulsation caused by the split surface increases.

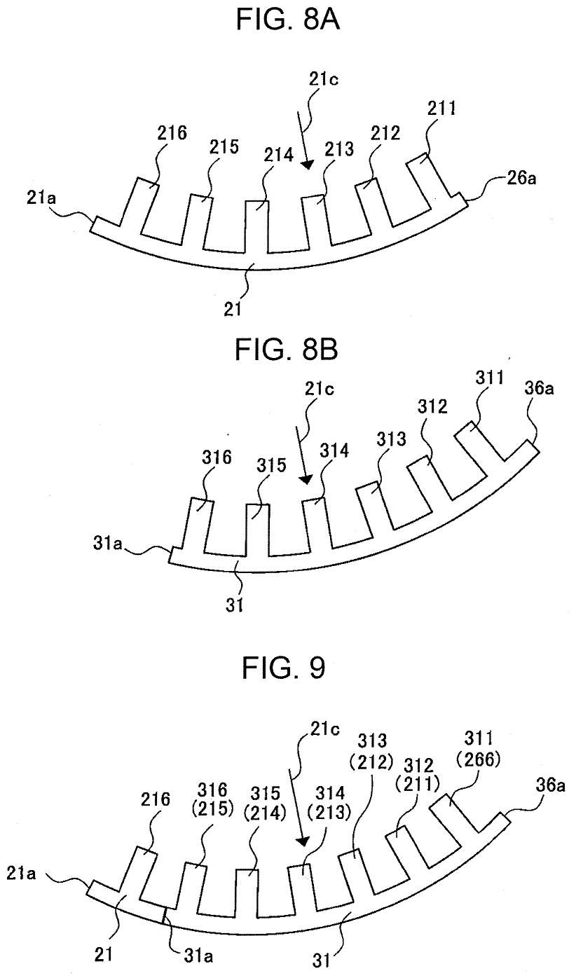

Next, a method of disposing the split cores of the first stator 2 and the split cores of the second stator 3 will be described. FIG. 8A illustrates a plan view of the single split core 21 of the first stator 2 constituting the electric motor according to Example 1 of the present disclosure. Both end surfaces of the split core 21 are the split surfaces 21a and 26a. In addition, a central axis of the tooth 213 of the teeth 211 to 216 serves as the inversion symmetry axis 21c.

FIG. 8B illustrates a plan view of the single split core 31 of the second stator 3 constituting the electric motor according to Example 1 of the present disclosure. Both end surfaces of the split core 31 are the split surfaces 31a and 36a. In addition, a central axis of the tooth 314 of the teeth 311 to 316 serves as the inversion symmetry axis 21c. At this time, when the split core 21 illustrated in FIG. 8A is inverted across the inversion symmetry axis 21c, the split core 31 illustrated in FIG. 8B is formed.

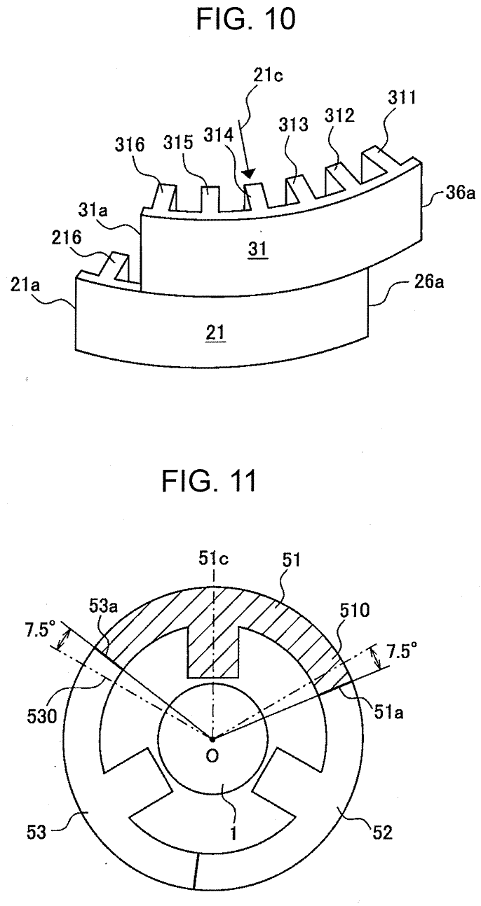

FIG. 9 illustrates a plan view of a state in which one split core of the first stator and that of the second stator, constituting the electric motor according to Example 1 of the present disclosure, are stacked with each other. FIG. 10 illustrates a perspective view of a state in which one split core of the first stator and that of the second stator, constituting the electric motor according to Example 1 of the present disclosure, are stacked with each other. When the split core 21 and the split core 31 are stacked aligned with the inversion symmetry axis 21c, the split core constituting the electric motor according to the present example can be formed.

As illustrated in FIGS. 8A and 8B, the split core 31 is obtained by inverting the split core 21 across the inversion symmetry axis 21c. Thus, when a split core is formed by stacking a plurality of electromagnetic steel plates, only one pattern can be punched out. Then, a split core of the first stator 2 can be formed by stacking a punched electromagnetic steel plate as is, and a split core of the second stator 3 can be formed by stacking a punched electromagnetic steel plate after inverting the punched electromagnetic steel plate. Thus, according to the present example, the split cores of the first stator and the second stator can be manufactured using one punching-out pattern, so that the manufacturing process of the split cores can be simplified.

Next, an electromagnetic device according to Example 2 of the present disclosure will be described. FIG. 11 illustrates a plan view of a first stator constituting an electric motor according to Example 2 of the present disclosure. While the number of poles of the rotor is set to 42, and the number of splits is set to 6 in Example 1, the present disclosure is not limited to this kind of example. An example where the number of poles of the rotor is set to 4 and the number of splits is set to 3 in the electric motor according to Example 2 will be described. In this case, a least common multiple of the number of poles of the rotor and the number of splits is 12. Thus, a period of torque pulsation caused by the split surfaces and the number of poles of the rotor is determined to be 2π/12 (rad).

Since the torque pulsation is caused at the same period in each of the first stator and the second stator, the torque pulsation can be suppressed by providing a phase difference a. The required phase difference a is determined by the following equation.

α=(2π/12)/2+n×(2π/12)=π/12,3π/12,5π/12, . . . (rad) (n=0,±1,±2 . . . )

A suitable value is selected from values of α calculated as described above. The first stator and the second stator are inverted and stacked, so that the first stator and the second stator may be displaced from respective split surfaces to have inversion symmetry by α/2.

As described above, in the electric motor according to the example of the present disclosure, a stator capable of suppressing torque pulsation caused by split surfaces can be easily manufactured.

1. An electric motor comprising:
a rotor having a plurality of magnetic poles;
a first stator provided with a plurality of teeth for winding a coil on its inner circumferential side, the first stator being disposed in an annular shape radially facing the rotor, the first stator being formed of a plurality of split cores each having teeth identical in number, the split cores being split along a plurality of split surfaces in a circumferential direction; and
a second stator stacked in an axial direction of the first stator, the second stator provided with a plurality of teeth identical in number with the teeth of the first stator, the teeth being disposed and aligned with the corresponding teeth of the first stator in the axial direction, the second stator being formed of a plurality of split cores being split along a plurality of split surfaces in the circumferential direction, wherein
a position of each of the split surfaces of the second stator is displaced from a position of the corresponding one of the split surfaces of the first stator in the circumferential direction by an angle α, and
the angle α being determined by an equation,
α=(2π/N)/2+n×(2π/N),
where N is a least common multiple of the number of magnetic poles of the rotor and the number of split cores, and n is an integer.

2. The electric motor of claim 1, wherein
one split core being freely selected of the plurality of split cores of the second stator has a shape acquired by inverting a split core of the plurality of split cores of the first stator across an inversion symmetry axis, the split core disposed to at least partly overlap the one split core,
the inversion symmetry axis passes through a predetermined tooth included in the split core of the first stator and a center of the first stator or passes through a predetermined slot and the center of the first stator,
an interior angle of the split core of the first stator is designated as θ,
an angle formed by the inversion symmetry axis and a split surface of the split core of the first stator is represented by θ/2−α/2, and
an angle formed by the inversion symmetry axis and a split surface of the one split core of the second stator is represented by θ/2+α/2.

3. The electric motor of claim 1, wherein
at least one split surface of the plurality of split surfaces of the first stator and at least one split surface of the plurality of split surfaces of the second stator are each disposed in a region between adjacent teeth of the plurality of teeth.

4. The electric motor of claim 1, wherein
the first stator has a length in the axial direction equal to a length of the second stator in the axial direction.
